(19) United States
(12) Patent Application Publication
(10) Pub. No.: US 2021/0347661 A1
(43) Pub. Date: Nov. 11, 2021

(54) SYSTEM AND METHOD FOR RESTORING WATER ENVIRONMENT BY A CONSTRUCTED WETLAND

(71) Applicant: CHINESE RESEARCH ACADEMY OF ENVIRONMENTAL SCIENCES, Beijing (CN)

(72) Inventors: Lieyu Zhang, Beijing (CN); Lulu Che, Beijing (CN); Xiaoguang Li, Beijing (CN); Guowen Li, Beijing (CN); Caole Li, Beijing (CN); Jiaqian Li, Beijing (CN); Wei Li, Beijing (CN); Qiuheng Zhu, Beijing (CN); Chen Zhao, Beijing (CN)

(21) Appl. No.: 17/280,937

(22) PCT Filed: Sep. 15, 2020
(86) PCT No.: PCT/CN2020/115350

§ 371 Date: Mar. 29, 2021

(30) Foreign Application Priority Data
Sep. 29, 2019 (CN) 201910931408.3

(51) Int. Cl. C02F 3/32; A01G 7/00; C02F 1/48; C02F 1/00

(52) U.S. Cl. CPC C02F 3/327; A01G 7/00; C02F 2101/30; C02F 1/006; C02F 1/484

(57) ABSTRACT

The disclosure relates to the field of water environment treatment, and more particularly to a system and a method for restoring a water environment by a constructed wetland. The system for restoring the water environment by the constructed wetland includes: (1) a water distribution pipe for inputting a water body to be treated into the constructed wetland; (2) a magnetization reactor arranged around the water distribution pipe and used for applying a magnetic field perpendicular to the water flow direction to the water body flowing through the water distribution pipe in order to make the water body entering the constructed wetland through the water distribution pipe become magnetized water after magnetization treatment; (3) the constructed wetland; (4) a magnetization reactor arranged in the vertical direction of the constructed wetland and used for applying a magnetic field to the constructed wetland in the vertical direction; and (5) a water outlet pipe used for discharging the water body treated by the constructed wetland. The water body to be treated passes through the water distribution pipe, is treated by the magnetization reactor arranged around the water distribution pipe and then enters the constructed wetland. Meanwhile, the magnetization reactor arranged in the vertical direction of the constructed wetland is used for intermittently magnetizing the constructed wetland, so that the technical problems of high blocking possibility during operation and difficult rapid restoration of the constructed wetland can be effectively solved.

### TECHNICAL FIELD

The disclosure relates to the field of water environment treatment, and in particular to a system and a method for restoring a water environment by a constructed wetland.

### BACKGROUND

A constructed wetland, as a sewage treatment technology with high efficiency, low investment, low operating cost, and low energy consumption, has attracted more and more attention from countries worldwide. However, the blockage of the constructed wetland system is one of the main factors affecting its application and popularization. After the constructed wetland is blocked, the permeability coefficient of a substrate drops sharply, and the discharge capacity of it also decreases accordingly. A large amount of sewage introduced into the wetland system will directly accumulate on the surface of the wetland, and long-term water accumulation will cause stench, lead to the breeding of mosquitoes and flies, and worsen the operating environment; the accumulated sewage will also block the diffusion of oxygen into the substrate layer, thereby reducing the removal effect of the constructed wetland on pollutants (especially organic matters and ammonia nitrogen), resulting in the failure that the effluent index cannot meet the original design standard, and meanwhile shortening the operation life of the constructed wetland.

Many factors may cause the blockage of the constructed wetland. At present, the main methods for solving the blockage problem of the constructed wetland are: improving the porosity of the filler, hydraulically adjusting the design, strengthening the pretreatment, replacing the substrate of the wetland, stopping bed operation and conducting an alternate operation, conducting bioremediation, designing a drainage deposition system, adding an inhibitor and a stripping agent, backwashing and aerating and oxygenating. However, the preventive effects of these methods on the blockage of the constructed wetland are quite different, and they often cure the symptoms rather than the root causes.

Moreover, the current methods for solving the blockage of the constructed wetland system still have the following shortcomings: (1) the hydraulic retention time needs to be shortened, which in turn affects the purification effect; (2) it is difficult to replace the wetland substrate, the engineering load for it is huge, at the time of replacing the wetland needs to be shut down by stopping the bed, and it takes a long time to replace the wetland substrate; (3) for the two measures of stopping bed operation and conducting alternate operation, in order to ensure the normal treatment level of a sewage treatment station, it needs to build multiple parallel wetlands, which will greatly increase the investment cost of the wetland system and be easily affected by the weather; (4) the measure of bioremediation is still in the research stage currently, and the actual engineering application effect has yet to be verified; (5) the removal of pollutants from the sewage by the constructed wetland mainly depends on the metabolic activity of microorganisms, and the method of solving the blockage by adding an inhibitor and a stripping agent to kill microorganisms or inhibit their activities still needs further research; and (6) other methods have problems such as complex operation, long required time, short duration, large engineering load, high time cost, poor economic benefit and easily caused secondary pollution.

Therefore, currently, there are no very good prevention or treatment/repair measures for the prevention of the blockage of the constructed wetland and the restoring after the blockage of the constructed wetland. Therefore, it is urgent to develop a method that can reduce or avoid the blockage of the constructed wetland and can repair the blockage quickly once it occurs to ensure the normal operation of the constructed wetland.

### SUMMARY

An objective of the disclosure is to provide a system and a method for restoring a water environment by a constructed wetland, so as to solve at least one technical problem existing in the prior art.

In order to realize the objective of the disclosure, the technical solution of the disclosure is as follows:

In the first aspect, the disclosure provides a system for restoring a water environment by a constructed wetland, as shown in FIG. 1, which includes: (1) a water distribution pipe for inputting a water body to be treated into the constructed wetland; (2) a magnetization reactor arranged around the water distribution pipe and used for applying a magnetic field perpendicular to the water flow direction to the water body flowing through the water distribution pipe in order to make the water body entering the constructed wetland through the water distribution pipe become magnetized water after magnetization treatment; (3) the constructed wetland; (4) a magnetization reactor arranged in the vertical direction of the constructed wetland and used for applying a magnetic field to the constructed wetland in the vertical direction; and (5) a water outlet pipe used for discharging the water body treated by the constructed wetland.

Further, the water distribution pipe and the water outlet pipe can be those conventionally used in the constructed wetland, for example, pipes with diameters of 50-500 mm can be selected.

Further, the upper and bottom portions of the constructed wetland are filled with a filler with a diameter of 15-50 mm, and plants are planted in the upper portion, and the middle portion is filled with a mixture of a filler with a diameter of 5-15 mm and iron filings, with the ratio of the iron filings to the filler being 1:3-1:8. By adding the iron filings, on the one hand, the dephosphorization effect of the constructed wetland can be increased, and on the other hand, the magnetization effect of the magnetized reactor on the constructed wetland can be enhanced.

Further, the 1/3-1/7 sections of the upper and bottom portions of the constructed wetland are filled with a filler with a diameter of 15-50 mm, and plants are planted in the upper portion, and the middle portion is filled with a mixture of a filler with a diameter of 5-15 mm and iron filings, with the ratio of the iron filings to the filler being 1:3-1:8. By adding the iron filings, on the one hand, the dephosphorization effect of the constructed wetland can be increased, and on the other hand, the magnetization effect of the magnetized reactor on the constructed wetland can be enhanced.

The filler may include, but is not limited to detritus, zeolite, gravel, sand, coal cinder, limestone, etc.

Preferably, the plants planted in the upper portion of the constructed wetland are emergent plants, which can be selected from one or more of Typha angustifolia (Narrowleaf cattail), Nelumbo nucifera, bowl lotus, Phragmites australis, Typha orientalis Presl, Zizania latifolia (wild rice shoots, or water bamboo), Arundo donax, Phyllostachys heteroclada, Schoenoplectus tabernaemontani, Acorus calamus, Cortaderia selloana, Sparganium stoloniferum, etc.

Preferably, the magnetization reactor arranged around the water distribution pipe and the magnetization reactor arranged in the vertical direction of the constructed wetland are electromagnetic magnetization reactors, and more preferably electromagnetic magnetization reactors with an adjustable magnetic field strength.

The water body to be treated (which can also be called sewage) can be a water body with water quality of class II-V, including but not limited to a eutrophic water body, a black and odorous water body, a landscape water body, etc.

In the second aspect, the disclosure provides a method for restoring a water environment by the aforementioned system for restoring a water environment by a constructed wetland. Specifically, the water body to be treated passes through the water distribution pipe, is treated by the magnetization reactor arranged around the water distribution pipe and then enters the constructed wetland, and meanwhile the magnetization reactor arranged in the vertical direction of the constructed wetland is used for intermittently magnetizing the constructed wetland, such that the water body is treated by the combined action of the magnetized water, the substrate of the constructed wetland, microorganisms, extracellular polymers, and plants, thereby promoting the ecological restoration of the water environment.

Further, the intensity of the magnetic field for magnetizing the water body in the water distribution pipe is 50 mT-1500 mT, and the magnetization time is 1 min-120 min.

Preferably, the intensity of the magnetic field for magnetizing the water body in the water distribution pipe is 100 mT-250 mT, and the water flow speed is 0.2 m/min-10 m/min.

Preferably, the intensity of the magnetic field for intermittently magnetizing the constructed wetland is 30 mT-800 mT, the time for single magnetization is 5 min-300 min, and the interval time is 3 h-240 h. That is, every 3 h-240 h, a magnetic field with the intensity of 30 mT-800 mT is applied to the constructed wetland for 5 min-300 min.

Preferably, the intensity of the magnetic field for intermittently magnetizing the constructed wetland is 50 mT-100 mT, the time for single magnetization is 30 min-45 min, and the interval time is 24 h-72 h. That is, every 24 h-72 h, a magnetic field with the intensity of 50 mT-100 mT is applied to the constructed wetland for 30 min-45 min.

According to the method for restoring the water environment by the constructed wetland as provided by the disclosure, the water body (or the sewage) to be treated can be treated and restored in a multi-level and multi-directional manner.

Before entering the constructed wetland, the sewage first passes through the water distribution pipe equipped with the electromagnetic magnetization reactor. Under the action of the magnetization reactor, water and organic pollutants in the sewage are rapidly magnetized in a short time. The magnetization action destroys the electrostatic attraction between molecules, which on the one hand enables the original long associated molecular chain in the water to be cut off into short associated molecular chains and charged ions so that a large water molecule cluster becomes small water molecule clusters or individual water molecules, the activity of water is improved, the surface tension of water molecules is enhanced, the permeability of water molecules is enhanced, and the transparency of the water body is increased. On the other hand, magnetization can mineralize the organic pollutants without adding chemical agents because the magnetization effect produced by the magnetization will destroy the chemical bonds of pollutant molecules, break the pollutant molecules, change them from large molecules to small molecules, convert carbon in the pollutant molecules into carbon dioxide, and convert nitrogen, phosphorus and the like pollutants into inorganic salts. The magnetized sewage enters the constructed wetland. Because of the advantages of the magnetized sewage, the efficiency of purifying the sewage in the constructed wetland will be enhanced, the cycle will be shortened, and the blockage of the wetland will be reduced.

After the sewage enters the constructed wetland, with the operation of the constructed wetland, under the interception action of the stems and leaves of plants and the filler, a part of the sewage stays between the stems and leaves of plants, and the other parts of the sewage gather on the surface and pores of the substrate. The constructed wetland is magnetized intermittently during the operation of the constructed wetland. Through the combined action of the magnetized water, the substrate, the microorganisms, the extracellular polymers, and the plants, the wetland can operate continuously for more than one year, without any blockage phenomenon and with normal purification efficiency.

Specifically, the beneficial effects of intermittently magnetizing the constructed wetland are as follows:

In the first aspect, it can enable microcurrent to be formed on the surface of the substrate of the constructed wetland, and the sewage will flow circularly under the action of the microcurrent during continuous seepage of it in the substrate, and thus will not accumulate on the surface and pores of the substrate. Oxygen in the substrate will become active oxygen under the action of magnetization. Thus the reoxygenation ability of the atmosphere will be enhanced, which will increase the redox potential of the substrate. If the redox potential is high, the oxidation ability of the microorganisms will be strong, and the accumulation of the extracellular polymers will be relatively slow, so that the pores of the substrate will not be blocked by flocculent aggregates with a larger particle size formed due to the adsorption and coagulation of colloidal or suspended substrates with different particle sizes by extracellular polymers.

In the second aspect, the molecular weight of the functional group of the extracellular polymer is relatively large, and the magnetization effect caused by magnetization will destroy the molecular action of the extracellular polymer, so that the macromolecular extracellular polymer will be transformed into macromolecular substances, which cannot be combined with the suspended particles through the actions of ionic bonds and hydrogen bonds, and then cannot be deposited by forming a network structure, and thus the flocculation ability will disappear.

In the third aspect, it can also promote and enhance the production of extracellular enzymes. By enhancing the degradation of extracellular polysaccharides, the degradation action of the extracellular enzymes on the extracellular polymer can be enhanced, so that the extracellular polymer can be degraded into small molecules and absorbed into cells, which can resist the harm of antimicrobial agents and toxic substances to cells.

In the fourth aspect, the magnetization effect can promote the formation of a microenvironment at an oxidized state around the roots of plants in the constructed wetland and promote the growth of the roots of plants. When the growth of the roots is tending to be mature, the continued application of magnetization will promote the rapid transformation of pollutants adsorbed by the plants, break the limit of maximum biomass, and keep the removal rate of pollutants at a certain level.

In the fifth aspect, the magnetization effect can not only promote the formation of an aerobic environment suitable for survival of aerobic microorganisms in the constructed wetland, but also promote the formation of an anaerobic environment suitable for survival of anaerobic microorganisms in the constructed wetland, such that different microorganisms can coexist and take their own needs, fully absorb and utilize nutrients in water, and eutrophic substances in water are reduced, thereby continuously purifying the water quality.

If the constructed wetland is magnetized continuously without rest, it will increase the probability of deformity of plants and animals and will inhibit the absorption and purification actions of the plants, animals, and microorganisms. Therefore, compared with continuous magnetization, intermittent magnetization can not only save resources and costs, but also have a higher safety performance and a better pollutant removal effect.

The raw materials involved in the disclosure may be common commercially-available products, and the operations involved in the disclosure are normal operations in the art, unless otherwise specified.

On the basis of conforming to the common knowledge in the art, the aforementioned preferred conditions can be combined with each other to obtain specific embodiments.

The beneficial effects of the disclosure are as follows.

The disclosure provides a system and a method which can effectively solve the blockage of the constructed wetland and restore the water environment by utilizing a magnetization manner.

The system is simple in structure, low in cost, convenient to build and operate, and the restoring method is low in energy consumption, simple in operation, long in effective time and does not cause any secondary pollution.

The technical solution of the disclosure effectively solves the technical problems in the prior art that the constructed wetland is easily blocked during operation and difficult to quickly restore and provides new ideas and solutions for the construction of the constructed wetland and the treatment of the water environment.

### BRIEF DESCRIPTION OF THE DRAWINGS

FIG. 1 is a schematic diagram of a structure of the system for restoring a water environment by a constructed wetland according to the disclosure.

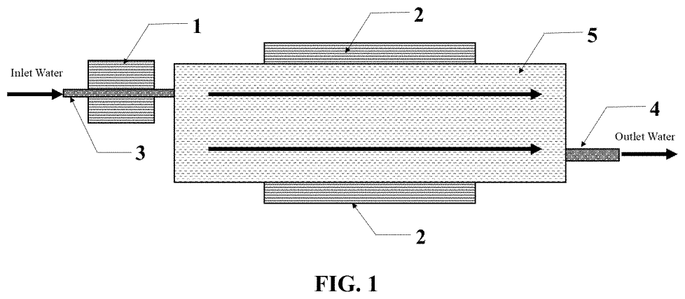

In the FIGURE: 1: a magnetization reactor (for magnetizing the water body in a water distribution pipe), 2: a magnetization reactor (for magnetizing a constructed wetland), 3: the water distribution pipe, 4: a water outlet pipe, and 5: the constructed wetland.

### DETAILED DESCRIPTION OF THE EMBODIMENTS

The preferred implementation modes of the disclosure will be further described in detail hereafter with reference to embodiments. It should be understood that the following embodiments are given for illustrative purposes only and are not intended to limit the scope of the disclosure. Those skilled in the art can make various modifications and substitutions to the disclosure, without departing from the tenets and spirit of the disclosure.

The experimental methods used in the following embodiments are conventional methods, unless otherwise specified.

The materials, reagents, etc. used in the following embodiments are commercially available, unless otherwise specified.

### Embodiment 1

In the laboratory, the constructed wetland constructed by the method of the disclosure may be simulated, and the constructed wetland models numbered A, B, C, D, E and F may be selected. Each of the constructed wetlands had a covering area of 3200 cm², and the reactor may be 80 cm long, 40 cm wide and 40 cm high. The left and right sides of the reactor may be respectively provided with a water distribution pipe and a water outlet pipe both with a diameter of 100 mm, the water flow speed may be 0.5 m/min, and the time for passing through the water distribution pipe may be 5 min. The reactors A, D, and F may be respectively electromagnetic magnetization reactors with a magnetic field intensity of 100 mT arranged around the water distribution pipes, and an electromagnetic magnetization reactor with a magnetic field intensity of 50 mT may be arranged in the vertical direction of the water flow in the constructed wetland model; the reactor B may be an electromagnetic magnetization reactor with a magnetic field strength of 100 mT arranged around the water distribution pipe; the reactor C may be an electromagnetic magnetization reactor with a magnetic field strength of 50 mT arranged in the vertical direction of water flow in the constructed wetland model; the reactor E may be an electromagnetic magnetization reactor with a magnetic field strength of 100 mT arranged around the water distribution pipe, and an electromagnetic magnetization reactor with a magnetic field strength of 30 mT may be arranged in the vertical direction of the water flow in the constructed wetland model.

In the constructed wetland reactor, the 1/3 sections of the upper and bottom portions may be filled with detritus with a diameter of 30 mm; the middle portion may be filled with a mixture of coarse sand and iron filings with a diameter of 25 mm, with the ratio of the iron filings to the coarse sand being 1:5. Typha angustifolia and Schoenoplectus tabernaemontani may be planted in the upper portion of the reactor of the constructed wetland at the planting ratio of 1:1. The water body entering the water distribution pipe may be controlled to have a COD concentration of 80 mg/L, a TN concentration of 10 mg/L and an ammonia nitrogen concentration of 10 mg/L.

When water flowed into reactors A and E, the magnetization reactor may be turned on until the inflow of water may be completed, wherein the intermittent magnetization period may be 24 h, the magnetization time may be 30 min, and the magnetization may be continuously operated for 6 months. When water flowed into reactor B, the magnetization reactor may be turned on until the inflow of water may be completed, intermittent magnetization may be not performed, and the magnetization may be continuously operated for 6 months. No magnetization may be conducted when water flowed into reactor C, and when the inflow of water may be completed, intermittent magnetization may be conducted, wherein the intermittent magnetization period may be 24 h, the magnetization time may be 30 min, and the magnetization may be continuously operated for 6 months. When water flowed into reactor D, the magnetization reactor may be turned on until the inflow of water may be completed, wherein the intermittent magnetization period may be 72 h, the magnetization time may be 30 min, and the magnetization may be continuously operated for 6 months. When water flowed into the reactor F, the magnetization reactor may be turned on until the inflow of water may be completed, wherein the magnetization of the constructed wetland may be conducted for 6 months. It is to be noted that the constructed wetland using reactor A operated at a good state, without blockage in 6 months, with smooth drainage and good removal efficiency; the constructed wetlands using reactors B and F may be slightly blocked at 4 months, and seriously blocked at 6 months, with poor removal efficiency; the constructed wetlands using reactors C, D and E operated at a general state, and may be slightly blocked at 6 months, with a relatively good removal efficiency.

TABLE 1

| Time | A | B | C | D | E | F |
|---|---|---|---|---|---|---|
| Magnetization reactor for | Turn | Turn on | Not | Turn | Turn on | Turn on |
| the inlet water | on | | turn | on | | |
| | | | on | | | |
| Intensity of the magnetic | 100 | 100 | 0 | 100 | 100 | 100 |
| field of the inlet water | | | | | | |
| Intermittent magnetization | Turn | Not turn on | Turn | Turn | Turn on | Continuous |
| by the reactor | on | | on | on | | magnetization |
| Magnetization intensity of | 50 | 0 | 50 | 50 | 30 | 50 |
| the reactor (mT) | | | | | | |
| Magnetization action time | 30 | 0 | 30 | 30 | 30 | 6 months |
| of the reactor/min | | | | | | |
| Magnetization cycle of | 24 | 0 | 24 | 72 | 24 | 6 months |
| the reactor/h | | | | | | |
| % COD removal rate at 2 | 94.7 | 52.3 | 78.6 | 85.3 | 86.7 | 53.4 |
| months | | | | | | |
| % TN removal rate at 2 | 97.3 | 55.9 | 73.4 | 88.5 | 89.4 | 55.7 |
| months | | | | | | |
| % ammonia nitrogen | 96.5 | 53.5 | 76.9 | 86.4 | 85.1 | 52.7 |
| removal rate at 2 months | | | | | | |
| % COD removal rate at 4 | 95.6 | 49.6 | 77.5 | 86.3 | 85.4 | 54.0 |
| months | | | | | | |
| % TN removal rate at 4 | 96.9 | 50.7 | 76.3 | 83.9 | 85.5 | 54.7 |
| months | | | | | | |
| % ammonia nitrogen | 97.3 | 52.4 | 74.1 | 84.7 | 84.8 | 51.4 |
| removal rate at 4 months | | | | | | |
| % COD removal rate at 6 | 95.2 | 45.3 | 75.7 | 82.5 | 83.2 | 50.2 |
| months | | | | | | |
| % TN removal rate at 6 | 98.2 | 44.5 | 72.4 | 85.6 | 84.1 | 50.8 |
| months | | | | | | |
| % ammonia nitrogen | 95.6 | 48.5 | 71.7 | 83.2 | 85.0 | 49.7 |
| removal rate at 6 months | | | | | | |
| Initial permeability | 0.1 | 0.1 | 0.1 | 0.1 | 0.1 | 0.1 |
| coefficient of the filler | | | | | | |
| (m/s) | | | | | | |
| Permeability coefficient | 0.07 | 0.001 | 0.01 | 0.03 | 0.02 | 0.001 |
| of the filler at 4 months | | | | | | |
| (m/s) | | | | | | |
| Permeability coefficient | 0.06 | 0.0006 | 0.005 | 0.008 | 0.009 | 0.0007 |
| of the filler at 6 months | | | | | | |
| (m/s) | | | | | | |

### Embodiment 2

In a certain city, experimental constructed wetlands A, B, C, D, E, and F may be constructed by the method of the disclosure. Each of the constructed wetlands had a covering area of 64 m², and may be 8 m long, 8 m wide and 3 m high. The left and right sides of the constructed wetland may be respectively provided with a water distribution pipe and a water outlet pipe both with a diameter of 500 mm, the water flow speed may be 2.5 m/min, and the time for passing through the water distribution pipe may be 20 min. The experimental constructed wetlands A, D and F may be respectively provided with electromagnetic magnetization reactors with a magnetic field intensity of 250 mT arranged around the water distribution pipes, and an electromagnetic magnetization reactor with a magnetic field intensity of 100 mT may be arranged in the vertical direction of the water flow in the constructed wetland model; the experimental constructed wetland B may be provided with an electromagnetic magnetization reactor with a magnetic field strength of 250 mT arranged around the water distribution pipe; the experimental constructed wetland C may be provided with an electromagnetic magnetization reactor with a magnetic field strength of 100 mT arranged in the vertical direction of water flow; the experimental constructed wetland E may be provided with an electromagnetic magnetization reactor with a magnetic field strength of 250 mT arranged around the water distribution pipe, and an electromagnetic magnetization reactor with a magnetic field strength of 50 mT may be arranged in the vertical direction of the water flow.

In the constructed wetland, the 1/3 sections of the upper and bottom portions may be respectively filled with gravel with a diameter of 50 mm; the middle portion may be filled with a mixture of zeolite and iron filings with a diameter of 30 mm, with the ratio of the iron filings to the zeolite being 1:4. Acorus calamus and Phragmites australis may be planted in the upper portion of the constructed wetland at the planting ratio of 1:2. The water body entering the water distribution pipe may be controlled to have a COD concentration of 200 mg/L, a TN concentration of 30 mg/L, and an ammonia nitrogen concentration of 40 mg/L.

When water flowed into reactors A and E, the magnetization reactors may be may be turned on until the inflow of water may be completed, wherein the intermittent magnetization period may be 72 h, the magnetization time may be 45 min, and the magnetization may be continuously operated for 1 year. When water flowed into the reactor B, the magnetization reactor may be turned on until the inflow of water may be completed, intermittent magnetization may be not performed, and the magnetization may be continuously operated for 1 year. No magnetization may be conducted when water flowed into reactor C, and when the inflow of water may be completed, intermittent magnetization may be conducted, wherein the intermittent magnetization period may be 72 h, the magnetization time may be 45 min, and the magnetization may be continuously operated for 1 year. When water flowed into reactor D, the magnetization reactor may be turned on until the inflow of water may be completed, wherein the intermittent magnetization period may be 144 h, the magnetization time may be 45 min, and the magnetization may be continuously operated for 1 year. When water flowed into the reactor F, the magnetization reactor may be turned on until the inflow of water may be completed, wherein the magnetization of the constructed wetland may be conducted for 1 year. It could be seen that the constructed wetland using the reactor A operated at a good state, without blockage in 1 year, with smooth drainage and good removal efficiency; the constructed wetlands using reactors B and F may be slightly blocked at 5 months, and seriously blocked at 1 year, with poor removal efficiency; the constructed wetlands using reactors C, D and E operated at a general state, and may be slightly blocked at 1 year, with a relatively good removal efficiency.

TABLE 2

| Time | A | B | C | D | E | F |
|---|---|---|---|---|---|---|
| Magnetization reactor for | Turn | Turn on | Not | Turn | Turn on | Turn on |
| the inlet water | on | | turn | on | | |
| | | | on | | | |
| Intensity of the magnetic | 250 | 250 | 0 | 250 | 250 | 100 |
| field of the inlet water | | | | | | |
| Intermittent magnetization | Turn | Not | Turn | Turn | Turn on | Continuous |
| by the reactor | on | turn on | on | on | | magnetization |
| Magnetization intensity of | 100 | 0 | 100 | 100 | 50 | 100 |
| the reactor (mT) | | | | | | |
| Magnetization action time | 45 | 0 | 45 | 45 | 45 | 1 year |
| of the reactor/min | | | | | | |
| Magnetization cycle of | 72 | 0 | 72 | 144 | 72 | 1 year |
| the reactor/h | | | | | | |
| % COD removal rate at 4 | 88.6 | 32.3 | 70.3 | 77.9 | 80.4 | 30.5 |
| months | | | | | | |
| % TN removal rate at 4 | 89.0 | 39.5 | 71.6 | 78.4 | 79.4 | 31.7 |
| months | | | | | | |
| % ammonia nitrogen | 92.6 | 37.6 | 72.2 | 76.1 | 75.1 | 33.4 |
| removal rate at 4 months | | | | | | |
| % COD removal rate at 8 | 89.3 | 30.7 | 70.7 | 75.4 | 78.7 | 30.1 |
| months | | | | | | |
| % TN removal rate at 8 | 88.2 | 36.5 | 70.4 | 73.9 | 79.8 | 29.7 |
| months | | | | | | |
| % ammonia nitrogen | 88.8 | 38.2 | 70.1 | 74.7 | 76.3 | 30.6 |
| removal rate at 8 months | | | | | | |
| % COD removal rate at | 86.4 | 30.5 | 69.2 | 74.4 | 79.4 | 27.8 |
| 12 months | | | | | | |
| % TN removal rate at 12 | 87.7 | 34.1 | 69.9 | 72.0 | 77.6 | 28.8 |
| months | | | | | | |
| % ammonia nitrogen | 87.8 | 30.0 | 70.1 | 71.9 | 74.3 | 27.5 |
| removal rate at 12 months | | | | | | |
| Initial permeability | 0.1 | 0.1 | 0.1 | 0.1 | 0.1 | 0.1 |
| coefficient of the filler | | | | | | |
| (m/s) | | | | | | |
| Permeability coefficient | 0.05 | 0.0009 | 0.02 | 0.03 | 0.03 | 0.0008 |
| of the filler at 5 months | | | | | | |
| (m/s) | | | | | | |
| Permeability coefficient | 0.04 | 0.0001 | 0.001 | 0.004 | 0.005 | 0.0001 |
| of the filler at 12 months | | | | | | |
| (m/s) | | | | | | |

Although the disclosure has been described in detail with general description and specific embodiments hereinabove, it is obvious to those skilled in the art that some modifications or improvements can be made on the basis of the disclosure. Therefore, all such modifications or improvements made without departing from the spirit of the disclosure are within the claimed scope of the disclosure.

1. A system for restoring a water environment by a constructed wetland, comprising:
a water distribution pipe for inputting a water body to be treated into the constructed wetland;
a magnetization reactor arranged around the water distribution pipe and used for applying a magnetic field perpendicular to the water flow direction to the water body flowing through the water distribution pipe in order to make the water body entering the constructed wetland through the water distribution pipe become magnetized water after magnetization treatment;
a magnetization reactor arranged in the vertical direction of the constructed wetland and used for applying a magnetic field to the constructed wetland in the vertical direction; and
a water outlet pipe used for discharging the water body treated by the constructed wetland.

2. The system according to claim 1, wherein the upper and bottom portions of the constructed wetland are filled with a filler with a diameter of 15-50 mm, and plants are planted in the upper portion, and the middle portion is filled with a mixture of a filler with a diameter of 5-15 mm and iron filings, with the ratio of the iron filings to the filler being 1:3-1:8.

3. The system according to claim 2, wherein the plants planted in the upper portion of the constructed wetland are emergent plants, which can be selected from one or more of Typha angustifolia, Nelumbo nucifera, bowl lotus, Phragmites australis, Typha orientalis Presl, Zizania latifolia, Arundo donax, Phyllostachys heteroclada, Schoenoplectus tabernaemontani, Acorus calamus, Cortaderia selloana, Sparganium stoloniferum, etc.

4. A method for restoring a water environment by a constructed wetland, comprising:
inputting, using a water distribution pipe, a water body to be treated into the constructed wetland;
applying, using a magnetization reactor arranged around the water distribution pipe, a magnetic field perpendicular to the water flow direction to the water body flowing through the water distribution pipe to make the water body enter the constructed wetland through the water distribution pipe become magnetized water after magnetization treatment;
applying, using a magnetization reactor arranged in the vertical direction of the constructed wetland, a magnetic field to the constructed wetland in the vertical direction; and
discharging, using a water outlet pipe, the water body treated by the constructed wetland, wherein the water body to be treated passes through the water distribution pipe, is treated by the magnetization reactor arranged around the water distribution pipe, wherein the water body to be treated passes through the water distribution pipe and then enters the constructed wetland; and
magnetizing the constructed wetland by the magnetization reactor arranged in the vertical direction of the constructed wetland.

5. The method according to claim 4, wherein the intensity of the magnetic field for magnetizing the water body in the water distribution pipe is 50 mT-1500 mT, and the magnetization time is 1 min-120 min.

6. The method according to claim 5, wherein the intensity of the magnetic field for magnetizing the water body in the water distribution pipe is 100 mT-250 mT, and the water flow speed is 0.2 m/min-10 m/min.

7. The method according to claim 4, wherein the intensity of the magnetic field for intermittently magnetizing the constructed wetland is 30 mT-800 mT, the time for single magnetization is 5 min-300 min, and the interval time is 3 h-240 h.

8. The method according to claim 7, wherein the intensity of the magnetic field for intermittently magnetizing the constructed wetland is 50 mT-100 mT, the time for single magnetization is 30 min-45 min, and the interval time is 24 h-72 h.

9. The method according to claim 4, wherein the water body to be treated is a water body with water quality of class II-V.

10. The system according to claim 1, wherein the system is placed in the water environment treatment.
